(19) United States
(12) Patent Application Publication
(10) Pub. No.: US 2008/0152226 A1
(43) Pub. Date: Jun. 26, 2008

(54) Apparatus, Method and Program for Information Processing

(75) Inventor: Masayuki Ryuto, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 11/793,717

(22) PCT Filed: Dec. 22, 2005
(86) PCT No.: PCT/JP2005/024170

§ 371 Date: Sep. 27, 2007

(30) Foreign Application Priority Data
Dec. 24, 2004 (JP) 2004-373944

(51) Int. Cl. G06K 9/32; G06K 9/00

(52) U.S. Cl. 382/190; 382/118

(57) ABSTRACT

A personal computer (12) executes an information processing program (43) to start a shooting process. Under the shooting process, an extraction circuit (48) reads thumbnail image data from a HDD (42). The extraction circuit (48) analyzes the thumbnail image data, and extracts a partial image including a human face. A monitor (13) displays a whole of the image (whole image) (63), which is created from an original image data, and the partial image (64) extracted by the extraction circuit (48), together on a picture window (60).

### TECHNICAL FIELD

The present invention relates to an information processing apparatus, an information processing method and an information processing program for an image capture system, which is utilized in a photographic studio specializing in memorial shots and commercial shots.

### BACKGROUND ART

Recently, an image capture system, which can receive a print order of images immediately after shooting, has been brought into photo studios specializing in memorial shots and commercial shots. Such image capture system has an information processing apparatus, like a personal computer, for processing the images captured by a digital camera, and a monitor for displaying the captured images and print order information of these images (see Japanese Laid-open Patent Application No. 2002-139805).

In the image capture system disclosed in the Japanese Laid-open Patent Application No. 2002-139805, correction conditions for color, hue, saturation, sharpness and the like, are predetermined for each camera, and desired pictures are obtained efficiently by processing the images in accordance with these correction conditions. In the above-mentioned image capture system, a frame of the captured image is displayed on the monitor of the personal computer to be viewed by a customer. By reviewing the image displayed on the monitor, the customer considers whether to try another shooting.

When customers order printing of memorial pictures, they pay the most attention to composition of a whole image and an expression of face in the image. In order not to perform an unnecessary shooting, it has to be decided whether the shooting should be continued or not by reviewing the composition of the whole image and the expression of face in the image all the time during the shooting. The system described in the Japanese Laid-open Patent Application No. 2002-139805, however, merely displays the captured image as a whole on the monitor. To review the expression of face in the image, an extra job, such as manipulating a key board or a mouse of the personal computer for enlarging the displayed image, is necessary. Therefore, it is difficult to review the expression of face in the image immediately.

In view of the foregoing, an object of the present invention is to provide an information processing apparatus, an information processing method and an information processing program that facilitate review of the composition of the whole image and the expression of face in the image without any complicated job.

### DISCLOSURE OF INVENTION

In order to achieve the above and other objects, an information processing apparatus of the present invention includes an extractor and a display controller. The extractor analyzes image data obtained by shooting, and then extracts a partial image including a human face from a captured image. The display controller displays the extracted partial image and a whole of the image on an identical screen of a monitor.

It is preferable that the extractor extracts the partial image, whereas the display controller displays the partial image and the whole of the image immediately after the image is captured. It is also preferable that the extractor analyzes reduced image data, which is produced by reducing the image data, to extract the partial image. It is also preferable that the partial image is created for display from the reduced image data.

In a preferable embodiment of the present invention, a center portion of the image is displayed instead of the partial image when the partial image is not extracted. When a plurality of partial images is extracted, a desired one is selected to be displayed on the monitor from among the plurality of partial images. In another preferable embodiment of the present invention, a partial image having a highest possibility of an extracting target is displayed first when a plurality of partial images is extracted.

An information processing method of the present invention includes the steps of extracting and displaying. The extracting step extracts a partial image including a human face from an image after analyzing image data. The displaying step displays the partial image and a whole of the image on an identical screen of a monitor.

An information processing program of the present invention enables a personal computer to perform the steps of extracting and displaying. The extracting step extracts a partial image including a human face from an image after analyzing image data. The displaying step displays the partial image and a whole of the image on an identical screen of a monitor.

According to the information processing apparatus, method and program of the present invention, the extractor extracts the partial image including a human face from the image after analyzing the image data, and the display controller displays the extracted partial image and the whole image together on the identical screen of the monitor. Owing to this, it is possible to review the composition of the whole image and the expression of face in the image without any complicated job.

### BRIEF DESCRIPTION OF DRAWINGS

FIG. 1 is a schematic diagram showing a structure of an image capture system including a personal computer to which the present invention is applied;

FIG. 2 is a block diagram showing a structure of a digital camera;

FIG. 3 is a block diagram showing a structure of the personal computer;

FIG. 4 is an explanatory view showing a customer management window displayed on a monitor of the personal computer;

FIG. 5 is an explanatory view showing a picture window on which a partial image including a human face and a whole of the image are displayed;

FIG. 6 is an explanatory view showing the picture window on which a center portion of the image and the whole image are displayed; and

FIG. 7 is a flow chart showing a procedure of an information processing of the present invention.

### BEST MODE FOR CARRYING OUT THE INVENTION

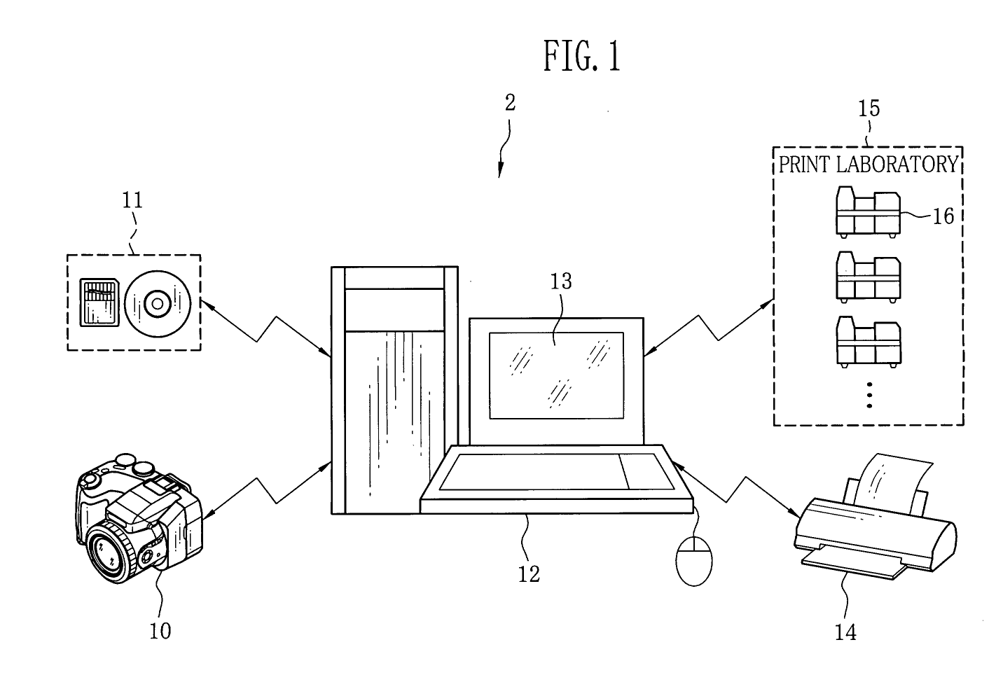

In FIG. 1, an image capture system 2 is provided in photo studios specializing in memorial shots like wedding shots, and commercial shots. The image capture system 2 imports image data obtained with a digital camera 10, or image data recorded in a recording medium 11, such as a memory card or CD-R, into a personal computer (hereinafter, abbreviated as PC) 12 and displays images on a monitor 13 of the PC 12 to receive a print order of the images. The image data recorded in the recording medium 11 includes images on photo films digitized into TIFF or JPEG format. The image capture system 2 then produces prints according to the print order, by a printer 14 equipped in the photo studio or by laboratory printers 16 equipped in a laboratory 15.

The digital camera 10, the printer 14 and the laboratory printers 16 are connected to the PC 12 through, for instance, a communication cable compliant with IEEE 1394 or USB (Universal Serial Bus), a wireless LAN or the like, and communicate data with the PC 12 mutually. The recording medium 11 exchanges data with the PC 12 through a specific driver.

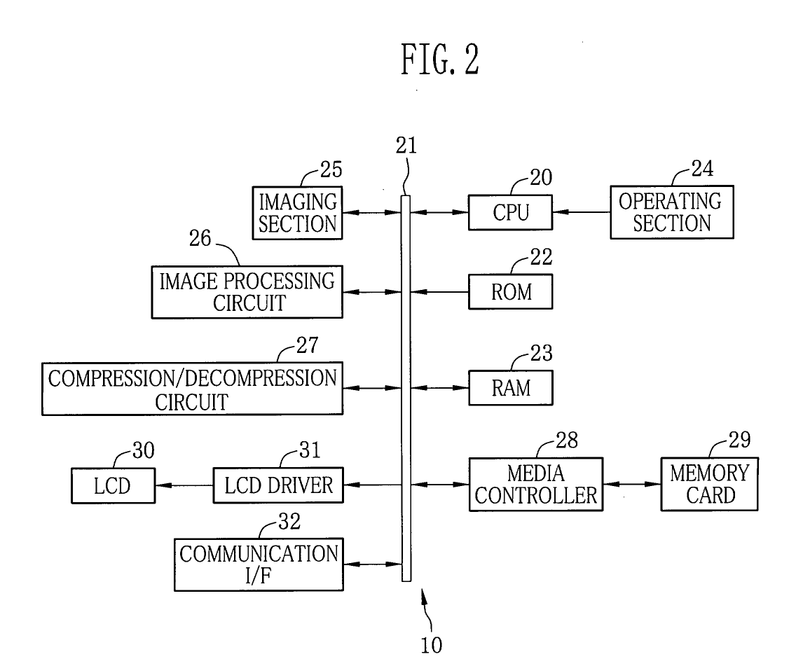

In FIG. 2, a CPU 20 is connected to all components of the digital camera 10 through a data bus 21, and comprehensively controls operations of the digital camera 10. A ROM 22 stores various programs and data necessary for the operation of the digital camera 10. The CPU 20 reads the programs and data from the ROM 22 to execute various processing. The CPU 20 operates every component of the digital camera 10 in accordance with operations of an operating section 24. The operating section 24 is constituted of a shutter release button and set-up buttons to set up f-number, shutter speed, zoom magnification, ISO sensitivity and the like.

An imaging section 25 is provided with a well-known taking lens, CCD and A/D converter. The imaging section 25 performs photoelectric conversion of an optical image of a subject formed by the taking lens by use of the CCD. An image signal is then converted into image data and is outputted. The image data outputted from the imaging section 25 is temporarily stored in a RAM 23. The image data is raw image data (CCD RAW data) before going through image processing like white-balance correction and the like. One pixel is constituted of RGB data, and each color data is represented by 12 bits.

An image processing circuit 26 reads the raw image data from the RAM 23 to convert the 12-bit pixel data of each color into 8-bit pixel data, and applies thereto the white-balance correction, y correction and YC conversion to output original image data. The image processing circuit 26 thins out pixels of the original image data to produce reduced image data (hereinafter, referred to as thumbnail image data) of, for instance, 1280×960 pixels.

A compression/decompression circuit 27 compresses the image data of the original image and the thumbnail image according to JPEG format. The image data compressed by the compression/decompression circuit 27 is once written into the RAM 23, and then is recorded in a memory card 29 by a media controller 28.

Under the control of a LCD driver 31, an LCD 30 displays through images of subjects continuously during the shooting, or reproduces the images which are read from the memory card 29 and displays the reproduced images. A communication interface (I/F) 32 sends the raw image data outputted from, the imaging section 25, the image data of the original image and the thumbnail image compressed by the compression/decompression circuit 27 (hereinafter, referred to as compressed image data) to the PC 12 via the above mentioned communication cable or the wireless LAN.

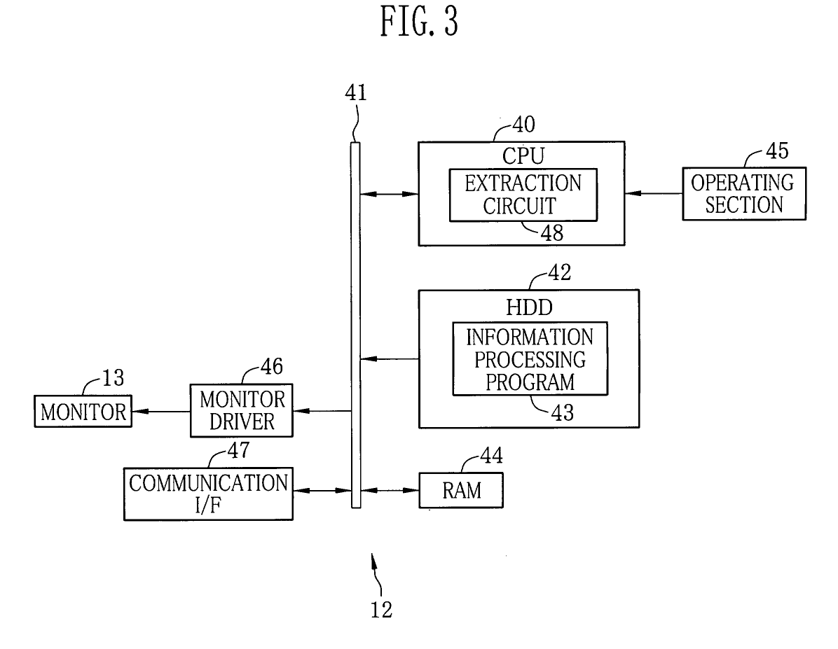

In FIG. 3, a CPU 40 is connected to all components of the PC 12 through a data bus 41, and comprehensively controls operations of the PC 12. A hard disk drive (HDD) 42 stores an information processing program (hereinafter, referred merely to as program) 43 as well as various programs and data necessary for the operation of the PC 12. The data stored in the HDD 42 includes the image data sent from the digital camera 10 and customer management data which is stored in connection with the image data. The customer management data contains personal information of customers, print order information and the like.

The program 43 allows the PC 12 to execute all processes of shooting with the digital camera 10, importing image data from the recording medium 11, presenting images to a customer for selection of the images to be printed, performing color correction, gradation correction or the like onto the image data, receiving the print order, sending it to the laboratory and producing an index print to check produced prints. The program 43 is recorded in the recording medium 11, such as CD-ROM, DVD-ROM, or the like, and is previously installed in the HDD 42 from the recording medium 11.

The CPU 40 loads the programs and data from the HDD 42 into a RAM 44, which is a work memory, to execute various processing. The CPU 40 operates every component of the PC 12 in accordance with directions inputted from an operating section 45 constituted of a keyboard and a mouse.

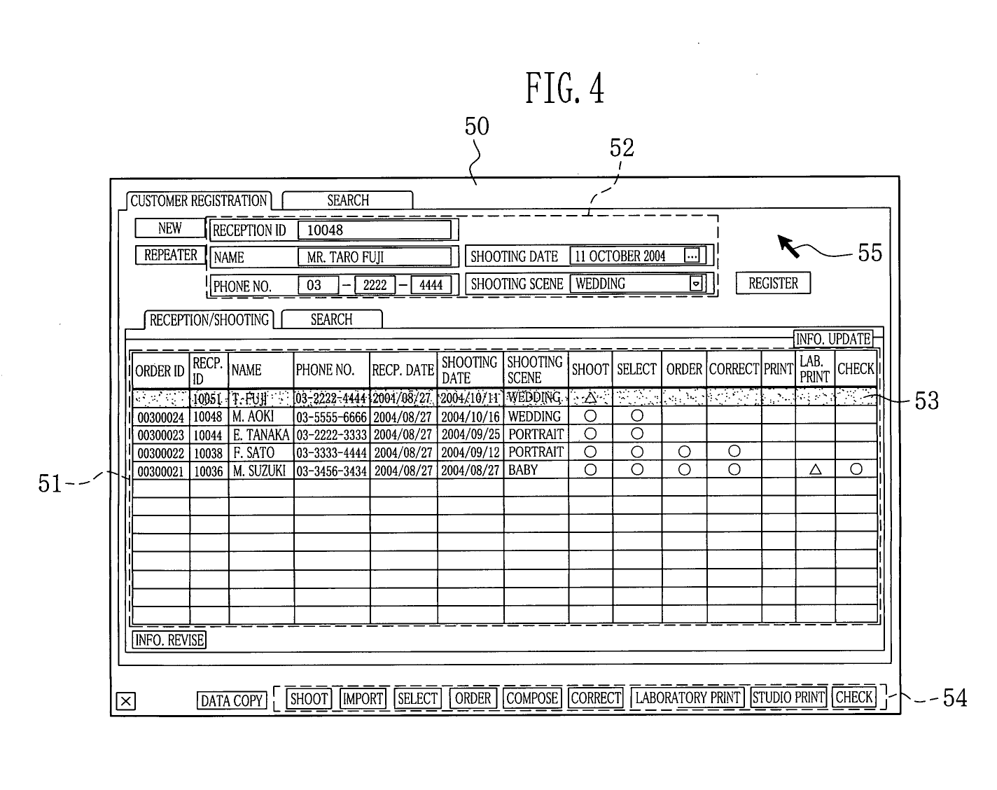

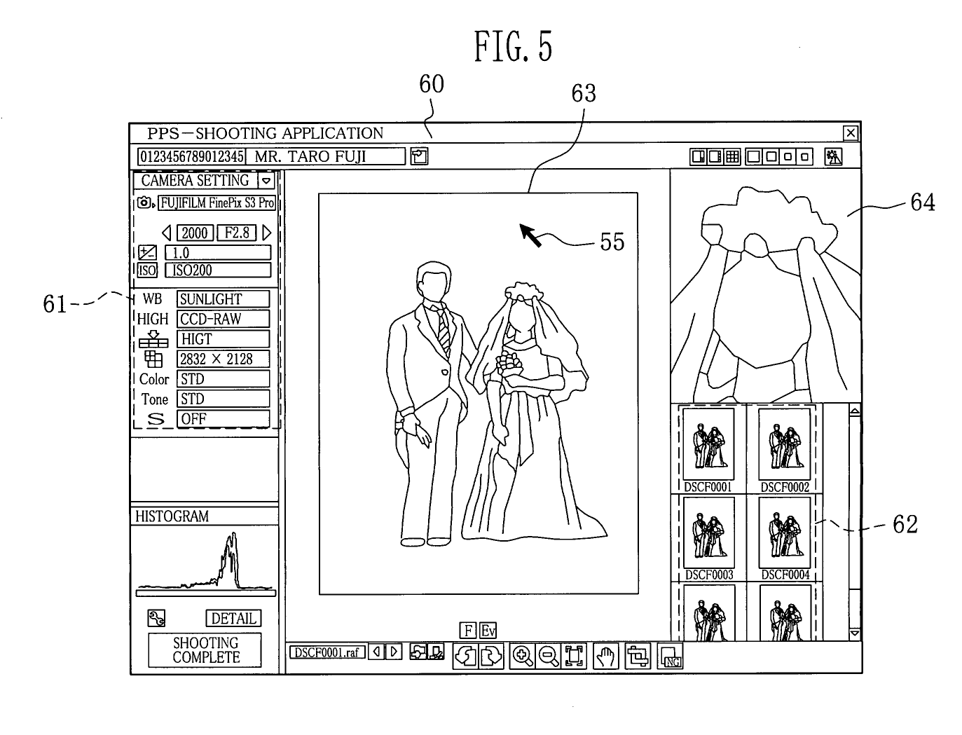

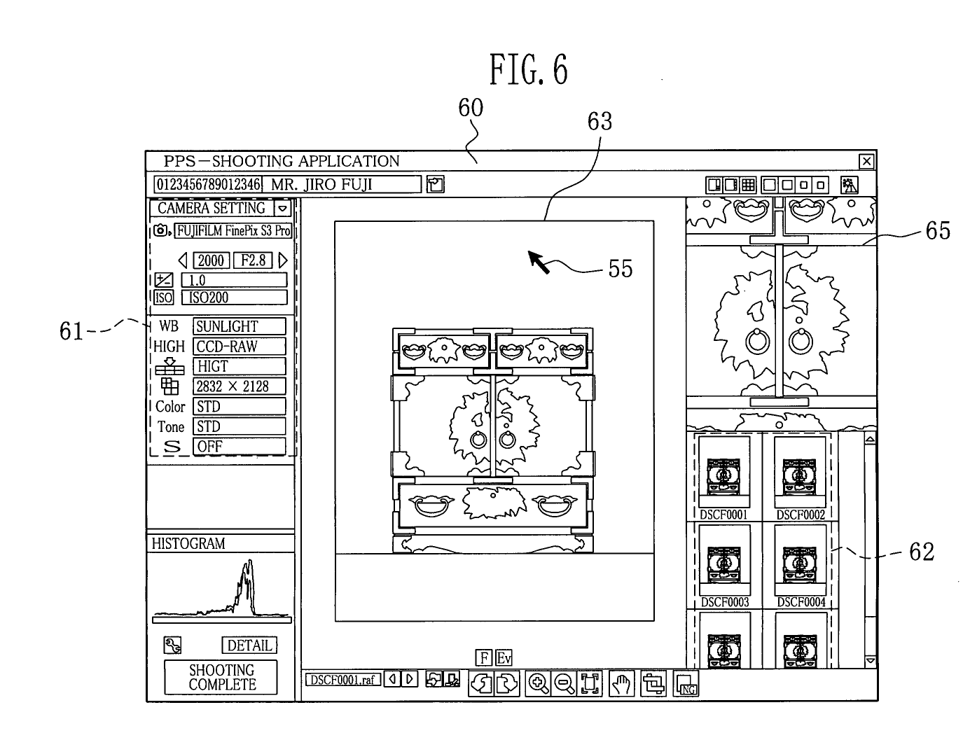

The monitor 13 displays a customer management window 50 (see FIG. 4) or a picture window 60 (see FIGS. 5 and 6) under the control of a monitor driver 46. These windows 50 and 60 are described later in detail. A communication I/F 47 receives the image data from the digital camera 10 or the recording medium 11, and transmits a command for printing to the printer 14 or the laboratory printers 16.

When the program 43 is started up in accordance with the operation of the operating section 45, the monitor 13 displays the customer management window 50, as shown in FIG. 4. On the customer management window 50, registration of new customers, correction or deletion of the registered information, search of the registered customers are performed in accordance with the operational directions inputted from the operating section 45. The customer management window 50 has a list 51 which displays a shooting date, a shooting scene (wedding, baby, etc.), progress of each process as well as personal information of customers (order ID, reception ID, name and phone number) of the image capture system 2. In the upper area of the customer management window 50, information 52 of the selected customer is shown. The selected customer is shown distinct from the other customers by a cursor 53 (shown by hatching) on the list 51.

In the lower area of the customer management window 50, buttons 54 (“SHOOT”, “IMPORT”, “SELECT”, “ORDER”, “COMPOSE”, “CORRECT”, “LABORATORY PRINT”, “STUDIO PRINT” and “CHECK” buttons) are provided. Placing a pointer 55 onto one of these buttons and clicking the mouse will lead to shift to the corresponding process and the window switches for the corresponding process.

When the “SHOOT” button is selected, a shooting process starts for assisting the shooting by the digital camera 10. As shown in FIG. 3, an extraction circuit 48 of the CPU 40 is activated upon starting the shooting process. The extraction circuit 48 reads the compressed image data of the thumbnail image from the HDD 42, and decompresses it. The extraction circuit 48 analyzes the thumbnail image data, and then extracts a partial image 64 including a human face from the image. Specifically, the extraction circuit 48 analyzes color tone of each pixel in the thumbnail image data and extracts pixels representative of skin color. The extraction circuit 48 then compares the proportion or shape of the skin color pixels in the image to template data representing the proportion or shape of a model face. Based on the comparison, the extraction circuit 48 calculates a score on how much the skin color pixels matches with the template data. When the calculated score is above a predetermined value, a gathering of the face color pixels is regarded as a human face. The extraction circuit 48 extracts a portion regarded as the face and its periphery as the partial image 64. The extraction circuit 48 alternatively extracts the human face with use of the well-known pattern recognition technique, in which specific parts of the face, such as eyes or a mouth, are searched. In this case, the score can be calculated in the same manner as mentioned above by using sample data representing the shape or position of eyes or a mouth. Moreover, it is also possible to use template data or sample data added with data representing features of a particular person (for instance, a bride etc.) to calculate a score on how much the skin color pixels matches with this template data or sample data.

Additionally, during the shooting process, the monitor 13 displays the picture window 60, as shown in FIG. 5. The picture window 60 displays shooting parameter information 61, such as the ISO sensitivity or the f-number, of the digital camera 10, a list 62 of the thumbnail images, a whole of the image (hereinafter, referred to as whole image) 63 created from the original image read from the HDD 42 and the partial image 64 extracted by the extraction circuit 48.

When a plurality of partial images 64 is extracted by the extraction circuit 48, the face selected by clicking the pointer 55 thereon is displayed as the partial image 64. Moreover, when a plurality of partial images 64 is extracted, the partial image 64 having a highest possibility of an extracting target (the image desired to be reviewed most), for instance, the largest one of the plurality of partial images 64 is displayed first on the picture window 60. Besides the partial image 64 having largest size, the one with highest score related to the proportion, shape or position of the whole face, eyes or mouth, or the one with highest score related to the particular parson may be displayed first.

Meanwhile, in a case where no human subjects appear in a shot, such as the commercial shots, the partial image 64 is not extracted by the extraction circuit 48. In this case, the monitor 13 displays a center portion of the image (hereinafter, referred to as center image) 65 instead of the partial image 64. The center image 65 is produced by cropping the image with a predetermined cropping frame.

Referring back to FIG. 4, when the “IMPORT” button is selected, an importing process starts. Under the importing process, the image data is imported from the recording medium 11 and is stored in the HDD 42. When the “SELECT” button is selected, a selecting process starts. Under the selecting process, the images are displayed on the monitor 13 as preview images, and the images to be printed are selected by the customer.

When the “ORDER” button is selected, an ordering process starts. Under the ordering process, print size and print number of the images selected under the selecting process are entered. When the “COMPOSE” button is selected, a composing process starts. Under the composing process, each of the selected images is arranged in a predetermined layout frame and an original photo album is produced. When the “CORRECT” button is selected, a correcting process starts. Under the correcting process, color correction, gradation correction or the like is performed on the image data so that the finished prints have the quality recommended by the photo studio provided with the image capture system 2.

When the “LABORATORY PRINT” button is selected, a laboratory printing process starts. Under the laboratory printing process, an order to print the images selected under the selecting process in the size and number set under the ordering process is placed to the laboratory printers 16 of the laboratory 15. When the “STUDIO PRINT” button is selected, a studio printing process starts. Under the studio printing process, the print order is placed to the printer 14. When the “CHECK” button is selected, a checking process starts. Under the checking process, an index print is produced for checking prints when the prints produced by the laboratory printers 16 of the laboratory 15 are delivered.

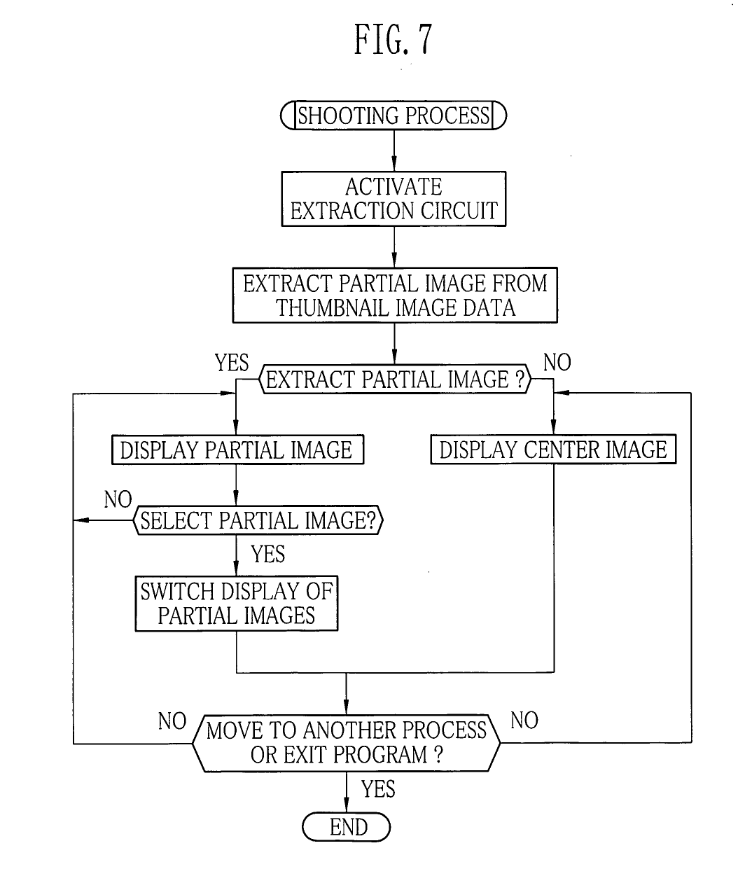

Next, a procedure of the information processing by the PC 12 is explained with referring to the flow chart shown in FIG. 7. Firstly, the operating section 45 is operated for starting up the program 43 to display the customer management window 50 on the monitor 13. On the customer management window 50, the registration of new customers, correction or deletion of the registered information, search of the registered customers are performed.

When the “SHOOT” button is selected to start the shooting process, the extraction circuit 48 of the CPU 40 is activated. When the shooting is performed with the digital camera 10, the raw image data, the compressed image data of the original image and the thumbnail image are produced and recorded in the memory card 29. These data recorded in the memory card 29 is inputted from the communication I/F 47 to be recorded in the HDD 42. Then, the compressed image data of the thumbnail image is read from the HDD 42 to the extraction circuit 48 and is decompressed. The thumbnail image data is analyzed by the extraction circuit 48, and the partial image 64 including a human face is extracted from the image.

The picture window 60 on the monitor 13 displays the enlarged partial image 64 along with the whole image 63. When a plurality of partial images 64 is extracted by the extraction circuit 48, the partial image 64 having a highest possibility of an extracting target is displayed first. In this case, the partial image 64 is switched to the one selected by clicking the pointer 55.

Meanwhile, when the partial image 64 is not extracted by the extraction circuit 48, the monitor 13 displays the center image 65 instead of the partial image 64. The information processing procedure is repeated until the executed process shifts from the shooting process to another or until the program 43 is completed.

When the shooting with the digital camera 10 is completed, each process is selected to be executed. Then, the prints according to the print order from the customer are produced by the printer 14 or by the laboratory printers 16. The produced prints are handed to the customer after the payment is made.

In the PC 12, the partial image 64 including a human face is extracted by the extraction circuit 48 by analyzing the image data obtained by shooting, and the extracted partial image 64 and the whole image 63 are displayed on the identical screen of the monitor 13. Owing to this, it is possible to review the composition of the whole image and the expression of face in the image easily without the complicated job, such as manipulating the key board or the mouse for enlarging the displayed image. In the present invention, the thumbnail image data is analyzed to extract the partial image 64. The thumbnail image data has relatively small amount of data rather than the raw image data or the original image data. Therefore, the time spent for analyzing is reduced. In addition to that, the image created from the thumbnail image data is displayed as the partial image 64 on the monitor 13. Therefore, the time spent for displaying is also reduced.

When the partial image 64 is not extracted by the extraction circuit 48, the monitor 13 displays the center image 65 instead of the partial image 64. Owing to this, commercial shots where no human subjects appear also look appropriate in the screen. When a plurality of partial images 64 is extracted by the extraction circuit 48, the partial image 64 to be displayed on the monitor 13 is selected from among the plurality of partial images 64. Owing to this, it is easy to review the expression of each face in the image. Moreover, when a plurality of partial images 64 is extracted by the extraction circuit 48, the partial image 64 having a highest possibility of an extracting target is displayed first on the picture window 60. Owing to this, an unnecessary operation like manual selection of the partial image 64 to be displayed can be avoided.

Note that the monitor 13 may be constituted of a touch panel for convenient operation. For this configuration, the customer can perform various selecting operations by touching the screen of the monitor 13.

There are no particular regulations for the display sizes of the partial image 64 and the center image 65, however, their display size is preferably determined in view of the display size of the whole image 63, and the viewability.

In the above embodiment, the partial image 64 and the whole image 63 are displayed together on the identical screen of the monitor 13 only during the shooting process. However, the partial image 64 may be displayed in other processes, such as the importing process, the selecting process, or the like.

### INDUSTRIAL APPLICABILITY

The information processing apparatus, information processing method and information processing program of the present invention is suitable for an image capture system, which is utilized in photo studios specializing in memorial shots and commercial shots.

1. An information processing apparatus for receiving a print order of an image displayed on a monitor, said image being captured by a digital camera and being stored in a memory as image data, said information processing apparatus comprising:
an extractor for extracting a partial image including a human face from said image after analyzing said image data; and
a display controller for displaying said partial image extracted by said extractor and a whole of said image on an identical screen of said monitor.

2. An information processing apparatus described in claim 1, wherein said extractor extracts said partial image, whereas said display controller displays said partial image and the whole of said image immediately after said image is captured.

3. An information processing apparatus described in claim 1, wherein said extractor analyzes reduced image data produced by reducing said image data.

4. An information processing apparatus described in claim 1, wherein said display controller displays said partial image created from reduced image data produced by reducing said image data.

5. An information processing apparatus described in claim 1, wherein said display controller displays a center portion of said image instead of said partial image when said partial image is not extracted by said extractor.

6. An information processing apparatus described in claim 1, further comprising:
a selector for selecting one of a plurality of partial images to be displayed on said monitor when said plurality of partial images is extracted by said extractor.

7. An information processing apparatus described in claim 1, wherein said display controller firstly displays a partial image having a highest possibility of an extracting target among a plurality of partial images when said plurality of partial images is extracted by said extractor.

8. An information processing method for receiving a print order of an image displayed on a monitor, said image being captured by a digital camera and being stored in a memory as image data, said information processing method comprising the steps of:
extracting a partial image including a human face from said image after analyzing said image data; and
displaying extracted said partial image and a whole of said image on an identical screen of said monitor.

9. An information processing method described in claim 8, wherein said extracting step and said displaying step are performed immediately after said image is captured.

10. An information processing method described in claim 8, wherein said extracting step analyzes reduced image data produced by reducing said image data.

11. An information processing method described in claim 8, wherein said displaying step displays said partial image created from reduced image data produced by reducing said image data.

12. An information processing method described in claim 8, wherein said displaying step displays a center portion of said image instead of said partial image when said partial image is not extracted by said extracting step.

13. An information processing method described in claim 8, further comprising the step of:
selecting one of a plurality of partial images to be displayed on said monitor when said plurality of partial images is extracted by said extracting step.

14. An information processing method described in claim 8, wherein said displaying step firstly displays a partial image having a highest possibility of an extracting target among a plurality of partial images when said plurality of partial images is extracted by said extracting step.

15. An information processing program for enabling a personal computer to receive a print order of an image displayed on a monitor, said image being captured by a digital camera and being stored in a memory as image data, said information processing program comprising the steps of:
extracting a partial image including a human face from said image after analyzing said image data; and
displaying extracted said partial image and a whole of said image on an identical screen of said monitor.

16. An information processing program described in claim 15, wherein said extracting step and said displaying step are performed immediately after said image is captured.

17. An information processing program described in claim 15, wherein said extracting step analyzes reduced image data produced by reducing said image data.

18. An information processing program described in claim 15, wherein said displaying step displays said partial image created from reduced image data produced by reducing said image data.

19. An information processing program described in claim 15, wherein said displaying step displays a center portion of said image instead of said partial image when said partial image is not extracted by said extracting step.

20. An information processing program described in claim 15, further comprising the step of:
selecting one of a plurality of partial images to be displayed on said monitor when said plurality of partial images is extracted by said extracting step.

21. An information processing program described in claim 15, wherein said displaying step firstly displays a partial image having a highest possibility of an extracting target among a plurality of partial images when said plurality of partial images is extracted by said extracting step.
